(19) United States
(12) Patent Application Publication
(10) Pub. No.: US 2008/0161008 A1
(43) Pub. Date: Jul. 3, 2008

(54) METHOD AND SYSTEM FOR IDENTIFICATION OF A COMMUNICATION DEVICE IN A WIRELESS COMMUNICATION NETWORK

(76) Inventor: Enoch Porat, Moshav Bnei - Zion (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/959,656

(22) Filed: Dec. 19, 2007

Related U.S. Application Data
(60) Provisional application No. 60/877,128, filed on Dec. 27, 2006.

(51) Int. Cl. H04Q 7/20

(52) U.S. Cl. 455/450

(57) ABSTRACT

The present invention discloses a system and a method for allocation of identifiers enabling identification of communication devices as terminals or access points in at least one wireless communication network and network operator.

According to some embodiments of the invention, the device itself may carry out the allocation, according to a predefined algorithm. At least one list of identifiers may be stored at the device. The communication device may enable, for example, randomly allocating of the identifier to be used, where the communication with the single destination associated with the device may be carried out by transmitting an identifier allocated from the list, validating the identifier at the operator and iterating these steps until the identifier is validated and a call may be executed between the device and the destination.

### CROSS-REFERENCE TO RELATED APPLICATIONS

This application claims the benefit under 35 U.S.C. § 119(e) of U.S. Provisional Patent Application No. 60/877,128 filed on Dec. 27, 2006, the content of which is incorporated by reference herein.

### FIELD OF THE INVENTION

The present invention relates generally to the field of wireless communication. More particularly, the present invention relates to identification of wireless communication devices in a communication network.

### BACKGROUND OF THE INVENTION

To enable communicating one communication device with another using a wireless network (e.g. wireless local loop (WLL) networks), each device has to be identified in the network operator as a valid terminal or access point. Allocating of identifying signals and sequences in a calculated manner may save many resources and time consumption.

Many systems that manage and supervise large numbers of wireless communication (machine-to-machine (M2M)) between communication devices such as cell phones, personal digital assistance (PDA) devices and the like, may use allocation techniques to save memory resources of the network operators.

Subscriber Identity Module (SIM) cards, for example, which are widely known and often used in cellular mobile phones, use authentication processes that involve transmitting an international mobile subscriber identity (IMSI) obtained from the SIM card to a mobile network operator (MNO) for authentication. To validate the access-point the operator searches its database to find the IMSI and its matching Ki and generates a second encrypted identifier. The associated Ki is the device's unique associated code stored at the SIM card as well as at the database enabling the validation of the access point. The operator generates a number and signs it with the associated Ki and transmits this combination to the device where the number is read using the Ki code and transmitted back to the operator for validation.

### SUMMARY OF THE INVENTION

The present invention discloses a system and a method for allocation of identifiers enabling identification of communication devices as terminals or access points in at least one wireless communication network.

According to some embodiments of the invention, the communication devices (CDs) may carry out the allocation.

According to some embodiments of the invention each CD associated with the system and the same destination, may comprise: (i) a power source; (ii) packaging; (iii) a transmitter enabling to transmit data to said destination and to at least one network operator using at least one wireless communication network; (iv) an application chip that enables processing and execution of allocation algorithm(s) enabling to allocate identifiers for identification of said device in said network as a terminal access point, wherein said allocation is carried out according to a predefined algorithm; and (v) a memory unit for storing of said identifiers as an at least one list of said identifiers and for storing of additional allocation related data.

According to some embodiments of the invention, the CD may enable executing calls to the destination by allocation and transmission of identifiers, stored in at least one list in the memory unit, where the identifiers may be allocated by the application chip.

According to some embodiments of the invention, the CD may repeat iterating the allocation and transmission of identifiers until validation of the identifier by the network operator is achieved.

According to some embodiments of the invention, the allocation may be carried out according to a predefined algorithm and techniques. For example, the allocation may be carried out by randomly selecting of an identifier out of the list with each iteration.

According to some embodiments of the invention, the CDs associated with the same destination may comprise positioning systems such as global positioning system (GPSs) enabling the devices to locate their position and allocate identifiers according to the detected location, where the devices may store several lists of identifiers each list associated with a specific network and/or area. The device's chip may enable selecting the specific list according to the identified location of the device.

According to some embodiments of the invention, each CD may have floating identifiers (FIs) for the purpose of allocation and identification in the network as a terminal as well as a constant Device Identifier (DI) uniquely identifying the CD itself and hence the user ascribed to it. The CD may enable:
allocating a predefined number of floating identifiers (FIs) to each communication device that is associated with a single destination, wherein each device may be associated with a single DI of the device itself;
transmitting the DI and the allocated FI to the network operator;
validating said identifiers, where the operator may enable validating the FI and DI identifiers and identifying of said device as a terminal;
executing a call between the CD and it associated destination.

According to some embodiments of the invention, at least one predefined group of a multiplicity of communication devices may be associated with a single destination and at list one list of predefined FIs. The method disclosed in this invention may enable at least some of the devices to simultaneously communicate with the destination by optimizing the allocation of identifiers according to a predefined algorithm. For example, associating a multiplicity of communication devices with a multiplicity of groups where the groups may be associated with a multiplicity of identifiers' lists. The allocation of the identifiers may be carried out by allocating an identifier for each communication device of each group out of a different list of identifiers to optimize the chances for transmission of valid identifiers when at least some of the communication devices may be operated simultaneously.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of communication route from a user to a destination, according to some embodiments of the invention.

FIG. 2 is a schematic illustration of a communication device, according to some embodiments of the invention.

FIG. 3 is a schematic flow diagram of a method for allocation of identifiers for the purpose of identification of communication devices as a terminals in a wireless communication network, according to some embodiments of the invention.

FIG. 4 is a schematic illustration of a distribution of communication devices ascribed to a single supplier destination, according to some embodiments of the invention.

FIG. 5 is a flow diagram schematically illustrating a process for allocation of identifiers in a system with a multiplicity of communication devices comprising positioning systems, according to some embodiments of the invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTION OF SOME EMBODIMENTS OF THE INVENTION

The present invention is a system and a method for wireless communication, wherein the system may include a communication device (CD) 11 (e.g. a cellular phone) that may enable dialing to and communicating with at least one designated destination via a wireless communication network. The method relating to the system may enable allocation of identification frequency enabling to identify the CD 11 as a terminal in a wireless communication network, where the allocation may be carried out within the CD 11 itself. The present invention may disclose several methods for allocating of identification frequencies according to embodiments of the invention.

According to some embodiments of the present invention, the CD 11 may enable communication through any type of wireless communication networking technology, such as radio frequency (RF) based wireless technologies: Worldwide interoperability for microwave access WiMAX, Mesh and the like.

Wireless communication networks use systems, such as Universal Mobile Telecommunication System (UMTS) or Global System for Mobile communications (GSM) that require terminal identification for the purpose of connecting and managing of calls from one terminal to another.

According to some embodiments of the present invention, the CD 11 may comprise a system that enables allocation and storage of identifiers, wherein these identifiers may be frequencies that Nay represent wireless communication networks identifications defining the CD 11 as a terminal in those networks.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

Mobile terminals can communicate with base stations that communicate with a network core. Communication traffic may be managed via the this network core. The network core shall be defined hereinafter as a “network operator” 103.

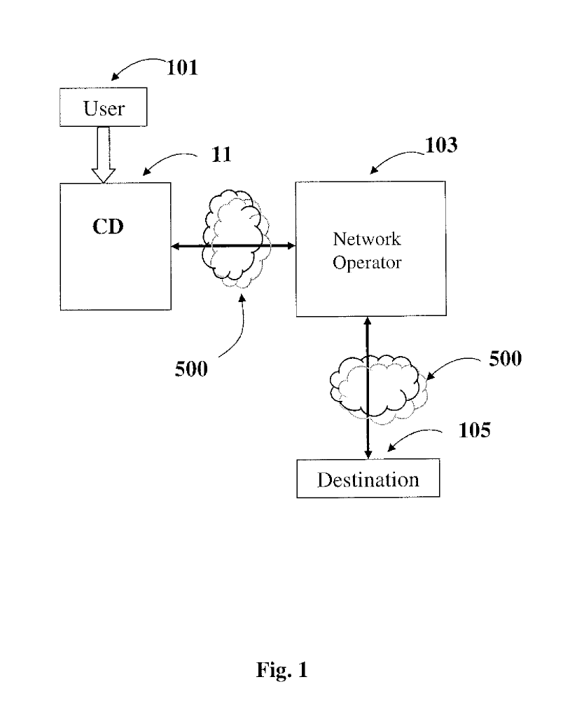

FIG. 1 schematically illustrates a communication route from a user 101 to a destination 105, according to some embodiments of the invention. User 101 may operate the CD 11 in order to contact a desirable destination 105. The CD 11 may be designated for a single destination 105 according to some embodiments of the invention. The CD 11 may transmit a signal to a communication network operator 103. The network operator 103 may receive the signal and connect the CD 11 and destination 105.

According to some embodiments of the invention, the network operator 103 may receive identifiers from terminals and check the online availability of the received identifiers. If the identifier of a terminal is available at the time of receiving this identifier, then network operator 103 may validate the identifier and allow communication for the identified terminal. If the identifier of a terminal is not available at the time of receiving the said identifier, then the network operator 103 may invalidate the identifier and may not allow communication for the terminal forcing the terminal to retry communicating with the operator 103 at a different time.

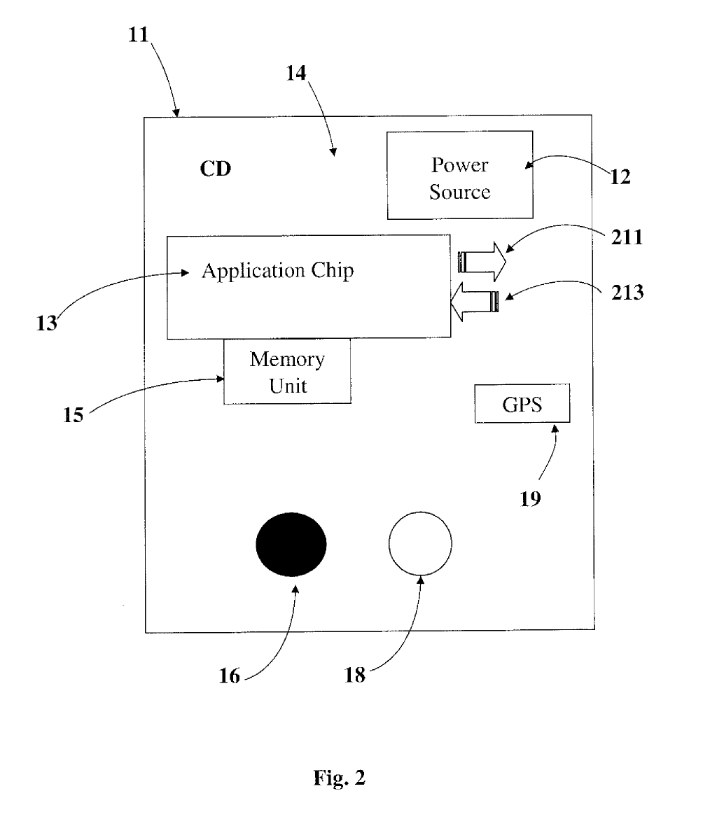

FIG. 2 is a schematic illustration of the CD 11, according to some embodiments of the invention, where the CD 11 may comprise:
a power source 12 that may be a rechargeable battery. The power source 12 may be solar or radio frequency (RF) energy based,
a packaging 14 of CD 11,
a dialer button 16 for dialing to destination 105 of the CD 11,
an end button 18 for ending communication with destination 105,
a transmitter 211 and a receiver 213 that enable communication with a communication network and the destination 105,
an application chip 13 that enables processing and execution of allocation algorithm(s) of identifiers, communication applications etc. and
a memory unit 15 for storing the CD 11 identifiers and other allocation related data.

According to some embodiments of the invention, the user 101 may press the dialer button 16 in order to contact the single destination 105. The CD 11 may automatically dial to and contact the destination 105 via the network operator 103. To end the call from the CD 11 the user 101 may press the End button 18.

According to additional or alternative embodiments of the invention, the CD 11 may comprise a speaker and/or earphones and a microphone to enable conversation between the user 101 and the destination 105. The CD 11 may also include a screen to enable graphical and visual representation, transmission and receiving of text (e.g. SMS messages), pictures, animation, video recordings etc.

According to some embodiments of the invention, the CD it may also comprise the following optional additions:
a positioning system 19 such as, for example, a Global Positioning System (GPS) that may enable locating of the CD 11 geographic position;
a label indicating the identification of the destination of CD 11;
indicators that may be visual or vocal, for example, miniature light bulbs for indicating the state of the power supply of the power source 12 and for indicating communication network 500 availability (another example: a sound that may be produced by the CD 11 to indicate that the power supply is running out);
at least one connector enabling to connect to at least one external identification and/or communication card such as a Subscriber Identity Module (SIM) card.

According to some embodiments of the invention, the system may additionally enable allocation of identifiers, where the identifiers may be stored in the CD 11 memory unit 15. The allocation may be carried out according to at least one technique or algorithm such as, for example, a roaming algorithm enabling to allocate identifiers according to the geographical position of the CD 11 and the available communication network corresponding to the geographical zone identified by the positioning system 19. For example, the CD 11 memory unit 15 may comprise several lists of identifiers each list corresponding to a specific communication network or a group of networks, where upon identifying the geographical zone and its available network(s), the algorithm may allocate an identifier (for example randomly) from a list that is corresponding to the available network.

According to some embodiments of the invention the algorithm according to which the allocation of identifiers may be carried out may be, for example a “random method”, in which an identifier may be randomly allocated out of a predefined list of identifiers stored in the memory unit 15 of the CD 11. This algorithm may include transmitting of a randomly allocated identifier to the communication network operator 103 and receiving validation or non-validation of the identifier from the network operator 103. The system may then continue allocating and transmitting of randomly allocated identifiers until the identifier is validated by the operator 103 and communication with the destination 105 is achieved.

According to some embodiments of the invention, the CD 11 may additionally enable allocating two types of identifiers depending on the requirements of the network(s) 500 available by the CD 11: (i) the device-identifier (DI) that may be a constant identifier that represents a specific CD 11 of a user, and a Floating Identifier (FI) that may be an allocated identifier chosen from a predefined finite list of identifiers. DI and FI list may stored in the memory unit 15 and allocated by application chip 13. The DI and FI identifiers may be specifically coded so that a wireless communication network may identify these identifiers as network 500 terminals.

According to some embodiments of the present invention, each destination 105 may be associated with several CDs 11. Each CD 11 may have a distinctive constant ODI, and each destination 105 may have a single list of FIs associated with the same destination 105. The number of FIs in a list of a destination 105 is represented herein as P. The number of CDs 11 associated with a single destination 105 is represented herein as N, whereas N may be much larger than P: N>>P where ±4 the FIs and DI of the CD 11 may be stored in the memory unit 15 and where the FI may be allocated by the application chip 13.

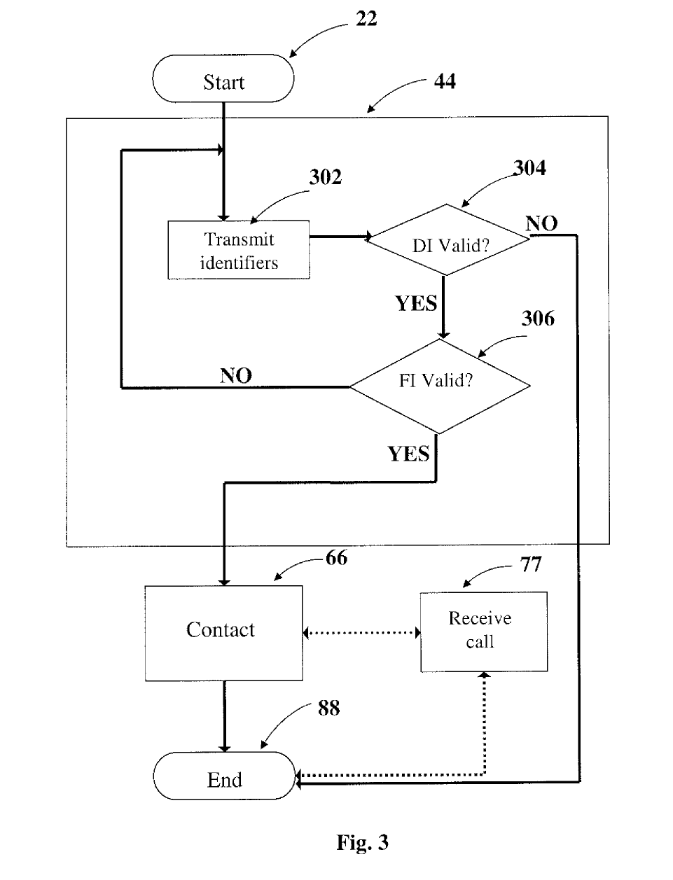

FIG. 3 schematically illustrates a flow diagram describing a method for identification and validation of the CD 11 as a terminal in network operator 103 of the communication network 500, according to some embodiments of the invention.

The identification and validation process may be defined as a “session” where each session may comprise the steps of:
starting communication 22 where the dialing button 16 may be pressed (by the user 101 or automatically) to contact the destination 105
validating of the CD 44, where the validation process may comprise the steps of:
   transmitting identifiers 302, where the CD 11 may extract the DI from the memory unit 15 and allocate an FI from the predefined FI list stored in the memory unit 15 and transmit the DI and the allocated FI to the network operator 103 for validation.
   Receiving the DI and FI from the CD 11, where the Operator 103 may receive the identifiers and check the validation of CD 11 identifiers in the network's registration:
   The network operator 103 may, for example, check the DI validation 304. The DI may not be valid if the CD 11 has expired or if the destination 105 is not valid in the network. If the DI is not valid then the network operator 103 transmit a non valid signal message to the CD 11 and the session may end 88.
   If the DI is valid, the network operator 103 may check the FI validation 306: the FI may not be valid if, for example, another user 101 of another CD 11 that is designated to the same destination 105 currently uses the same FI. If the FI is not valid then the network operator 103 may transmit a non-valid FI signal message to the CD 11 and the CD 11 may then randomly allocate another FI from the predefined list of FIs that is stored in the memory unit 15. The validation 44 process may then be iterated until a valid FI is found.
If the allocated FI is valid then the network operator 103 may enable communication with the destination 105, and the CD 11 may be permitted to
contact 66 destination 105. The destination 105 may then receive a call 77 from CD 11.
Ending of the session 88 when the contact with the destination 105 is initiated either by the user 101 or by the destination 105.

According to some embodiments of the invention, the application chip 13 of the CD 11 (and not the network operator 103) may carry out the DI validation check. The CD 11 may have a timing unit installed, where the timing unit may have an expiry date, so that when the CD 11 is expired the CD 11 may automatically turn off and does not enable dialing to the destination 105.

Additionally or alternatively, the timing unit may enable turning the CD II on and/or off according to a predefined set of rules to allow saving of battery energy.

According to some embodiments of the present invention, CDs 11 may be used for promoting and advertising businesses and commodities.

According to some embodiments of the invention, CDs 11 and designated to a single destination 105, may be used for promoting sales for businesses, defined hereinafter as “suppliers” 401 that may distribute free CDs 11 to potential customers for free calls services. The said destination 105 may be a telephone or any other device that enables communication via a wireless network.

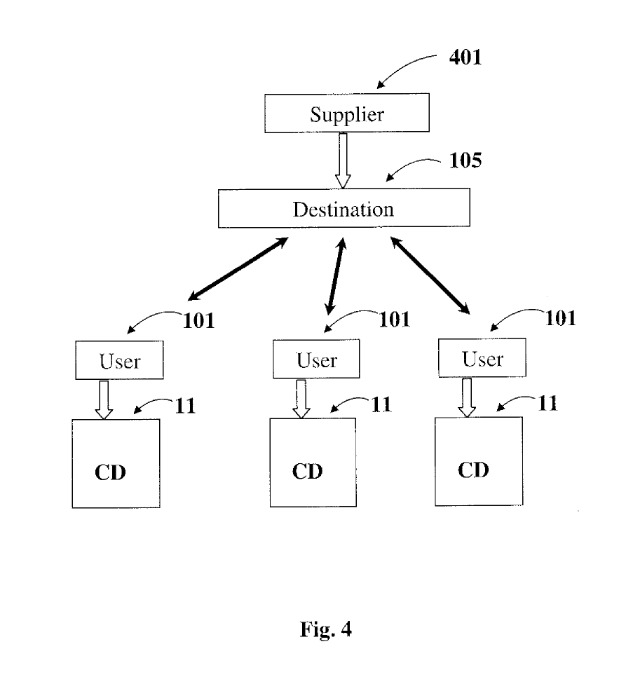

FIG. 4 schematically illustrates a distribution of CDs 11 ascribed to a single supplier 401. For example, supplier 401 may be a pizzeria that makes deliveries to its customers. The pizzeria as a supplier 401 may give out free CDs 11 to the users 101. The users 101 of the CDs 11 may then use the CDs 11 to make free calls to the pizzeria destination 105 and order home deliveries.

According to some embodiments of the present invention, the supplier 401 may be a company for emergency road services that gives tow services for vehicles. The users 101 may be car owners that use the CD 11 in case of need of towing services.

According to some embodiments of the present invention, the supplier 401 may use any device as the destination 105 that is suitable for communication with the CDs 11.

According to some embodiments of the present invention, the packaging 14 and size of the CDs 11 may be designed for the purpose of sales promotion. For example, to promote and advertise an emergency road services company the CDs 11 distributed by the said company, may be in a shape and a size of a sticker that may be pasted on a car dashboard. As another example, to promote and advertise a pizzeria CD 11 may be in a shape and a size of a magnet sticker that the users 101 can hang on a refrigerator etc.

According to some embodiments of the present invention, the system may enable an additional statistical application for representation and calculations of statistical parameters relating to the number of calls that are received by the destination 105. For example, if the destination 105 is designated for a pizzeria as the supplier 401, and the pizzeria had distributed a thousand CDs 11, the statistical application may show the percentage of CDs 11 that were utilized by the users 101. Representation and calculations may be carried out at the device that is used by the supplier 401 as the destination 105.

According to some embodiments of the present invention, the CD 11 may include an option for prerecorded advertising voice, visual and text messages that may automatically turn on while the user 101 is waiting for network communication, until said communication is achieved. For example: while the user 101 is waiting for network communication the user 101 may be able to here relaxing music, vocal advertisement of the supplier 401 or watch a funny cartoon via the CD 11 applications.

According to some embodiments of the present invention, the CD 11 may enable sending prerecorded messages through short message services SMS and multimedia messages services MMS to the destination 105. Prerecorded messages may be written, voice or visual messages and may be used for promoting the supplier 401 and the supplier's 401 latest news and commodities or services.

According to embodiments of the present invention, the CD 11 may be used as a passage card. For example, the destination 105 may be ascribed to a guarding post of a parking lot. All vehicles that are subscribed to the parking lot may hold the CDs 11 and may automatically be identified by the post for entering the parking lot.

According to embodiments of the present invention, CD 11 may be designated for a predefined number of the destinations 105. Dialing to the destinations 105 may be random; every time the user 101 presses, the dialer button 16 the CD 11 may randomly choose a certain the destination 105 out of a predefined list of the destinations 105. For example: (i) the CDs 11 are distributed to a group of single people for the purpose of finding a date; (ii) a group of women that receives the CDs 11 that are designated for a list of the destinations 105 of single men or vise versa. The CD 11 randomly allocates a destination 105 out of a predefined lists and a woman of the said group may call a single man from the designated group of men without knowing who he is. This can be used as a game for single people.

According to some embodiments of the present invention, CD 11 may allow sending the destination 105 a more detailed message through menu applications. For that purpose the CD 11 may include additional buttons, a screen and a preset menu for receiving said detailed message from the user 101. Each additional button may enable choosing a predefined feature out of a predefined menu list. Said message may be saved as a text message to the destination 105, while destination 105 may enable reading said message through a processing application, wherein said processing application may enable receiving said message, presentation of said message in a preset menu format and transmission of message confirmation. For example, the CD 11 may include four additional buttons of four different colors: green, blue, red and yellow, to represent four optional choices. The destination 105 may be connected to a restaurant computer. The preset menu may be the restaurant menu. The user 101 receives preset menu options and presses green button for a certain drink option and a yellow button for a different drink option. The menu may present a confirmation query to each menu choice, e.g. “to confirm coca cola press green button” etc. The message may be translated into strings of characters and sent to the destination 105. The restaurant computer may then analyze those strings and represent the message data in a restaurant-order format.

According to some embodiments of the invention, the CD 11 devices may comprise “reporting units” enabling a large quantity of CDs 11 to share a predefined number of FIs. The allocation of the FIs may be carried out according to a predefined algorithm or method, defining a set of rules, enabling to optimize the usage of a minimal number of FIs within a predefined time-interval in which the CDs 11 transmit reporting transmissions or messages to a control center, which may be the destination 105. For example, the CDs 11 may be connected to readers enabling to read measurements of energy units (e.g. power readers for measuring electric power consumption and utilization of power units). Each CD 11 may be connected to a single reader or a predefined group of readers enabling to transmit the reading parameters (e.g. power consumption units) to the control center. The allocation method that may be used for a large number of reporting units may define the timing cycles in which the reporting is carried out by each CD 11 according to the system's requirements and the optimization of the allocation of FIs. The allocation optimization algorithm may facilitate in optimizing the chances for achieving a valid allocated FI when simultaneously using a multiplicity of CDs 11 in order to communicate with the same destination 105.

For example, the reading units may report to the control center every month and transmit the utilization parameters through the CDs 11 to the control center destination 105. An optimization algorithm based upon a random allocation, processed by the application chip 13 may enable optimizing the allocation of FIs for each reporting unit CD 11 and manage the transmission timing. To allow for example, a group of “X” power readers associated with “N” CDs 11 that report once a month to the control center where there are 43,200 time-intervals within a month.

The ratio between the number “N” of CDs 11 available by the system to the number of available FIs “P” may be smaller or equal to:

N:P<42,300:1

Meaning one identity for each group of N CDs 11, which may be smaller than P. The system may be set according to much smaller ratios that still may save the number of FIs required (e.g. 10,000:1).

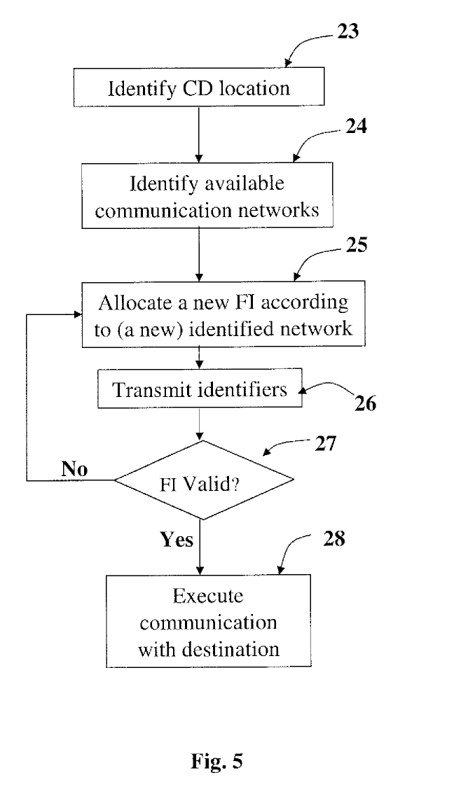

According to additional or alternative embodiments of the invention, the optimization allocation algorithm may be defined according to the requirements of the system. For example, as illustrated in FIG. 5, for systems in which the CDs 11 are geographically mobile (e.g. installed in cars for allowing parking prepaid parking) the CD 11 may comprise a positioning system such as a global positioning system (GPS) or any other positioning systems known in the art allowing to identify the location of the CD 11. The CDs 11 associated with the same destination 105 may enable:
identifying its own location 23;
identifying the communication networks 500 available in that location area 24;
allocating an FI according to a predefined list associated with one of the identified networks 25, where the CD 11 chip 13 may comprise an allocation algorithm enabling to allocate an FI such a soft SIM (subscriber identity module) or a soft UIC (universal integrated circuit) which may be software tools enabling to carry out the allocation upon identification of the identified mobile network operator (MNO) 103 and register as an identified terminal of the operator 103;
transmitting the identifiers 26, where the selected FI and the DI may be transmitted to the operator 103 associated with the located area for validation;
once the selected FI is validated 27, communication with the destination 105 may be executed 28.

According to some embodiments of the invention, for mobile CDs 11 serving as mobile reporting units, for example, the CDs 11 may be connected to or integrated with detection devices enabling to report detected parameters to the control center. For example, the system may be used to monitor a fleet of vehicles where the CDs 11 may be used to periodically transmit location parameters and enable automated parking through the control center using the CDs 11 attached to the vehicles to execute these transmissions of data.

According to some embodiments of the invention, the system may combine several groups of N CDs 11 and several groups of FIs lists each may have an equal or a non equal number of components, for example, 10 groups of CDs 11 where there are 100,000 CDs 11 each CD 11 group associated with a different group of FIs each comprising 10 different FIs. Assuming, for example, that the system requires simultaneously operating of 10 CDs 11, taking one of each group of CDs 11 may optimize the chances for achieving a valid FI and hence connecting the CDs 11 with their destination 105.

According to some embodiments of the invention, at least some of the different algorithms and methods for optimizing the allocation of FIs may be combined according to the system's requirements.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A method for allocation of identifiers for identification of a communication device as a terminal in a wireless communication network, wherein said allocation is carried out by said cellular devices, wherein said method includes the following steps:
allocating of an identifier out of at least one predefined list of identifiers, wherein said list is stored in the cellular device and wherein said allocation is carried out according to predefined rules;
transmitting said identifier to a communication network for validation of availability of the identifier.

2. The method of claim 1 further comprises the step of iterating the allocation step until validation by the communication network is achieved.

3. The method of claim 2 wherein said allocation is carried out by randomly selecting of an identifier out of said list with each said iteration.

4. The method of claim 1 wherein said list corresponds to at least one communication network.

5. The method of claim 4 further comprising the steps of locating the geographical position of said communication device using a positioning system comprised by said device, wherein said allocation is carried out once the geographical position of said device is located and the at least one network that is corresponding with said geographical position is identified.

6. The method of claim 5 further comprises the step of selecting a list of identifiers, wherein said list is associated with said communication network and wherein said selection is carried out by said communication device.

7. The method of claim 1 further comprises the steps of:
allocating a predefined number of floating identifiers (FIs) to each communication device that is associated with a single destination, wherein each said device is associated with a single Device-Identifier (DI) of the device itself;
transmitting said Di and said allocated FI to said operator;
validating said identifiers, wherein said operator enables validating the identifiers and identifying of said device as a terminal;
executing a call between said device and said destination;
wherein at least one predefined group of a multiplicity of communication devices is associated with said single destination and said at list one list of predefined FIs,
wherein said method enables at least some of said devices to simultaneously communicate with said destination.

8. The method of claim 1 wherein a multiplicity of devices are predefined within a multiplicity of groups that are associated with a multiplicity of identifiers' lists wherein said allocation of identifiers is carried out by allocating an identifier for each device of each group out of a different list of identifiers to optimize the chances for transmission of valid identifiers when at least some of said devices is operated simultaneously.

9. The method of claim 1 further comprises the step of combining several allocation algorithms and techniques to optimize the device's identification process according to the devices associated with the destination and the network operator's definitions.

10. A system for allocation of identifiers for identification of communication devices in a wireless network, said system comprising
a multiplicity of communication devices enabling to execute calls to a single destination;
at least one network operator;
at least one communication network;
wherein said system enables allocating identifiers to each communication device according to at least one predefined allocation optimization algorithm, wherein said algorithm enables a multiplicity of communication devices to execute calls to said destination simultaneously.

11. The system of claim 10 wherein said algorithm is based upon random allocation of identifiers out of at least one predefined list of a predefined number of identifiers, wherein said at least one list is stored in each of the communication devices ascribed to the system.

12. The system of claim 10 wherein at least some of the communication devices comprise positioning systems enabling to locate the geographical position of said devices and allocate an identifier for each device according to said location, wherein said allocation and positioning is carried out in said devices.

13. The system of claim 10 wherein said multiplicity of devices are predefined within a multiplicity of groups that are associated with a multiplicity of identifiers' lists,
wherein said allocation of identifiers is carried out by allocating an identifier for each device of each group out of a different list of identifiers to optimize the chances for transmission of valid identifiers when at least some of said devices is operated simultaneously.

14. A communication device that enables executing calls to a single predefined destination, said device comprising:
wherein said device enables executing calls to said destination by allocation and transmission of said identifiers.
a transmitter enabling to transmit data to said destination and to at least one network operator using at least one wireless communication network;
an application chip that enables processing and execution of allocation algorithm(s) enabling to allocate identifiers for identification of said device in said network as a terminal access point, wherein said allocation is carried out according to a predefined algorithm;
a memory unit for storing of said identifiers as an at least one list of said identifiers and for storing of additional allocation related data;
wherein said device enables executing calls to said destination by allocation and transmission of said identifiers to said operator, wherein said identifiers are allocated from said memory unit by said application chip.

15. The communication device of claim 14 further comprises a dialer button enabling a user to dial to said destination.

16. The communication device of claim 15 further comprises an end button for ending communication with said destination.

17. The communication device of claim 14 further comprises a positioning system,
enabling said device to locate the geographical area in which said device is located,
wherein said memory unit comprises a multiplicity of identifiers' lists, wherein each list is associated with at least one network that is associated with at least one geographical area enabling allocation of identifiers out of a list that is associated with the identified geographical area and the corresponding network.

18. The communication device of claim 14 further comprises at least one microphone and at least one set of earphones enabling the user to communicate with said destination.

19. The communication device of claim 18 wherein said device enable transmission and receiving of text messages.
